(19) United States
(12) Patent Application Publication
(10) Pub. No.: US 2024/0101826 A1
(43) Pub. Date: Mar. 28, 2024

(54) ASPHALT CONCRETE WITH AGGREGATES AND WASTE DERIVED FROM RECYCLED WASTE GLASS AND WASTE PLASTICS AND MANUFACTURING PROCESS

(71) Applicants: The Climate Change SRL, Cluj-Napoca (RO); Institutul de Cercetari în Transporturi - INCERTRANS S.A., Bucharest (RO)

(72) Inventors: Dennis DEBIE, Jud. Cluj (RO); Miron ZAPCIU, Cluj-Napoca (RO); Sebastian TUDOSE, Jud. Cluj (RO); Flavius-Valeriu CLADOVEANU, Bucharest (RO); Nicoleta-Mariana ENE, Bucharest (RO); Catalin DIMA, Bucharest (RO); Nicoleta-Adaciza IONESCU, Bucharest (RO); Monica COSTEI, Bucharest (RO)

(21) Appl. No.: 18/037,540

(22) PCT Filed: Oct. 11, 2022
(86) PCT No.: PCT/RO2022/050010

§ 371 Date: Jun. 22, 2023

(30) Foreign Application Priority Data
Dec. 17, 2021 (RO) A 2021 00793

(51) Int. Cl. C08L 95/00; C08K 3/013; C08K 11/00; E01C 7/26

(52) U.S. Cl. CPC C08L 95/00; C08K 3/013; C08K 11/005; E01C 7/26; C08L 2205/025; C08L 2205/035; C08L 2207/062; C08L 2207/066; C08L 2207/20

(57) ABSTRACT

The invention describes the compositions and the process of obtaining an asphaltic concrete for a single base and binder course (layer) of the road structure, composed of a bituminous mixture, containing aggregates derived from crushed and sorted recycled glass 0/4 and 4/8 mm and shredded plastic 0/10 mm. The new material is made up in two recipes: with total or partial replacement of conventional mineral aggregates: sand, rock aggregates and filler. The recipe partially replacing, but at least 20%, the conventional mineral aggregates, meets all the requirements according to AND IND 605-2018, required for the roads of technical class 3, 4 and 5.

The process of obtaining the new asphalt mixture material is characterized by the fact that the glass is mixed together with the aggregates and the filler at 160-180° C., bitumen heated to 180° C. is added and, after mixing the mixture for 30-35 sec., the shredded plastic constituent is added and further mixed for 10-15 sec., resulting in a polymerized asphalt mixture.

### 1. TECHNICAL SCOPE TO WHICH THE INVENTION RELATES

The invention relates to base and binder courses of road structures, The invention furthermore relates to recycling of glass and plastic waste, which are capable of replacing part of the mass of conventional rock aggregates.

### 2. STATE OF THE ART AND CURRENT INTERNATIONAL CONTEXT

Internationally, only a fraction of the plastics used end up in a recycling process. Ordinary recycling of plastics involves a large number of resources needed to separate and clean up a mixture of plastic waste (resin identification code 1, 2, . . . , 7 and ABS) and convert them into reusable pellets to make new plastic products, which in turn become waste after use. Since not all plastics are suitable for recycling, some of these materials are dumped directly into landfills or burned. The complexity and cost-effectiveness of the regular recycling process, combined with the low price of new plastics, explain the minimal efforts made to properly collect, use and manage the huge quantities of plastics.

Recycling waste glass involves a process of colour separation of waste glass so that new products can be made. The vast majority of glass waste is collected internationally in bulk, where no distinction is made between colors, and the collecting company is left with a mixture of unusable waste that will largely end up in landfills. In addition, the impurity of waste glass can be a problem for manufacturers of recycled glass products, leading to low commercial interest in these huge amounts of waste.

The invention aims to solve these drawbacks of the common recycling of plastic and glass waste by using them efficiently in road foundation layers. There is a clear need to recycle plastic and glass waste on a very large scale, without making a distinction between types of plastic, their molecular structure, color, density, etc. The same is true for waste glass, where color, purity, size etc. are not a problem for reuse.

This creates the conditions for a sustainable use of this waste, a continuous reduction of landfills, the prevention of toxic emissions, the protection of the environment and the improvement of the quality of life.

The addition of plastic and glass waste to asphalt mixtures has been studied, tested and applied internationally to obtain road structures, resulting in more durable and service-resistant asphalt layers and new methods of incorporating them into asphalt mixture.

One way of using plastic waste as a modifier in asphalt materials is described in some US patents: U.S. Pat. No. 3,891,585, author McDonald, C. H (1975); U.S. Pat. No. 3,919,148, author Winters R. E (1975); U.S. Pat. No. 4,068,023, author Nielson D. L (1978) and U.S. Pat. No. 6,844,418, author Forgac J. M (2005).

Another way of using two or more waste thermoplastics in asphalt mixtures is described by Brown H. J (1974), U.S. Pat. No. 3,852,046.

Fishback G. M (1997), in U.S. Pat. No. 5,702,199 proposes to use 5 . . . 20% granular plastic material to replace natural aggregates and be used as an intermediate pavement layer. Partanen, J. E, Ellis S. & Bartell D. (2010), US Patent No. 20100022686 propose another material consisting of granular solid aggregate, a granulated plastic additive and a binder.

The use of waste glass in asphalt materials was proposed by Sutton, P & Weston, S (2010) from the UK, in the European Patent No. 2162490, wherein waste glass is used to partially replace mineral aggregates to create an asphalt mixture.

Another strategy for incorporating glass into asphalt mixtures has been proposed by the Korea Inst. Civil Engineering & Building Technology by authors: Pyeongjun, Y. Booil K. Taeyoung Y. a. o. (2015), US Patent No. 2017081516, wherein glass fibers are coated with polypropylene resin, after which they are used as a substitute for mineral aggregates.

However, no technical documentation so far describes an asphalt mixture with a combination of waste glass and plastics of all types, irrespective of the Resin Identification Code etc., in solely granulated form and with partial or full replacement of mineral aggregates. Obtaining the new material does not require special machinery or additional steps in the process. The new material is put into operation using conventional recycling machines, hot mixing plants for asphalt mixtures and asphalt paving machines.

The published literature does not analyze the risk of burning of these plastic-modified asphalt materials when used as a surface (wearing) course. This risk is undeniably present and dangerous in the presence of increased traffic or road accidents accompanied by fire outbreaks. This risk of burning road surfaces will have an even greater impact when wildfires occur, and roads would be the only way out of the affected areas. All these considerations, together with the certainty of plastic microparticles reaching the atmosphere, lead to the conclusion that these materials cannot be used as a wearing course in road structures.

The road structure is composed of several layers supporting the final wearing surface layer. These layers are mostly composed of bound and unbound mineral aggregates such as rock and sand and typically account for about 75% of the total asphalt mixture mass.

Road surfaces are subject to traffic loads on a daily basis. This induces tensile stresses in the wearing course, binding and/or base layer of the asphalt mixture. Over time, irreversible deformations are caused in the solely rock-based foundation layers. Deformations of the foundation in turn cause weak points and ultimately large pits, cracks and deformations in the surface wearing course. These permanent deformations of unbound and bound layers are largely due to the fact that mineral aggregates are not elastic or compressible and, under load, can move irreversibly, causing failure of the surface layer. In addition, erosion of the granular, unbound foundation layer can cause further failure.

Mineral aggregates used in the road structure are a depletable material of the Earth and their exploitation involves intense labor, energy, costs, etc., accompanied by high emissions of gases into the atmosphere from the processes of extraction, processing/crushing, transport and use. Decreasing the quantities of mineral aggregates and increasing the amount of recycled aggregates in road structures will significantly reduce costs while protecting natural mineral resources and the environment.

### 3. TECHNICAL PROBLEMS THE INVENTION AIMS TO SOLVE

The first technical problem that the invention solves is to increase the degree of recycling and reuse of glass and plastic waste by using this waste in large quantities as aggregates for the proposed new material to be used in asphalt road structures. Other problems solved simultaneously consist of improving the durability of road surfaces and reducing the overall construction costs and emissions, by significantly reducing the quantities of conventional rock aggregates.

The main difference between the material proposed by this invention and other materials used in road infrastructure, which are covered by existing patents proposing either the use of plastic in various forms or the use of recyclable glass in asphalt materials, is that none of the existing patents include the use of all types of plastic and glass waste.

Another difference is that the material proposed by the present invention is that it uses plastic and glass waste simultaneously, in well-determined proportions and used as asphalt material to replace two classic layers in the road structure: base and binder.

Existing patents involve several steps in the preparation of plastic or glass materials before being used in the composition of asphalt material, whereas the material proposed by the present invention involves the direct use of waste granulated and delivered by companies specializing in recycling.

### 4. DISCLOSURE OF THE INVENTION AS CLAIMED

In order to achieve the objective of increasing the recycling of glass and plastic waste, the present invention provides the composition and method of making a mixture of materials for road base and binder courses composed partly of aggregates derived from glass and plastic waste.

According to the invention, this new material, hereinafter referred to as Littar, is capable of using large quantities of waste (at least 20% of the total mass of constituents) of glass and plastic of any type and color. The conversion of glass and plastic waste into materials to be reused in road infrastructures makes it possible to create new companies or grow existing ones to collect this waste and add value by converting it into granular base material for infrastructure applications.

The road structure is generally constructed using the following layers (FIG. 1) (each with its own composition and specific technical requirements):
a. Surface (wearing) course of asphalt mixture;
b. Binder course;
c. Base course;
d. Foundation layer (ballast, crushed stone)
e. Subgrade layer.

Littar is designed in particular as a base and binder course material as shown in FIGS. 2, 3 and 4. The use of recycled glass and plastics as part of the aggregate quantity results in an asphalt mixture with improved properties compared to the conventional mineral-based asphalt mixtures, through increased elasticity, resistance to cracking and permanent deformations, and reduced specific weight. The indirect improvement in the durability of the surface course leads to a decrease in the total construction costs of a road structure.

Littar can replace the sub surface courses: the binder course and the conventional base course, commonly used in road construction, except for the final surface/wear course. Littar can also be used as a foundation material for other paved surfaces including but not limited to: sidewalks, walkways, car parks, driveways and pedestrian roads, etc.

There are two main reasons not to use Littar for the wearing course: to prevent the creation of plastic microparticles entrained in the atmosphere during traffic and to prevent fires from traffic accidents, wildfires or other sources being sustained and spread over larger areas by the flammability of plastic materials.

By replacing at least two layers of the road structure (binder and base) with Littar product, the overall thickness of the road coating is reduced. As the specific weight (density) of the Littar mixture is also lower, the efficiency of transporting these materials to the placing site is increased, by reducing transport mass, costs and emissions.

Littar also reduces the negative influence of temperature differences, frost or rain, due to its waterproof and insulating properties, compared to rock-only alternatives, preventing cracking or erosion of the granular base or natural subsoil/foundation due to water run-off.

In addition, the exploitation of natural mineral aggregates requires the opening of quarries, labor and emissions, while shredded plastics and crushed glass waste are abundantly available locally. Littar is a pragmatic solution for reducing non-recycled waste as well as improving the quality of road infrastructure.

### 5. PRESENTATION OF ADVANTAGES OF INVENTION

Increased elasticity of the road structure, resistance to cracking and permanent deformation;
Decreased specific weight compared to conventional asphalt mixtures;
Reduced number of layers of the road structure by eliminating the binder course;
Decreased total construction costs of a road structure;
Lower consumption of natural mineral aggregates in the construction of road structures;
Environmental protection by increasing the recycling of glass and plastic waste.

### 6. PRESENTATION OF THE FIGURES

FIG. 1 shows, at a scale close to the real one, the 5 conventional layers of the road structure: a) the surface/wearing course; c+b) the base and binder course; d) the foundation course and e) the subgrade layer represented by the natural ground.

FIG. 2 shows the asphalt concrete called Littar course, which can replace both layers of the road structure shown in FIG. 1: the binder course and the base course.

FIG. 3 shows the Littar material course replacing only the binder course, and FIG. 4 shows the version where only the base course of the road structure is replaced.

FIG. 5 shows the components of the Littar asphalt mixing plant by the final mixing of the components in the element generically called batch mixer.

FIG. 6 shows the components of the asphalt mixing plant, in the version with continuous mixing in a rotary mixer.

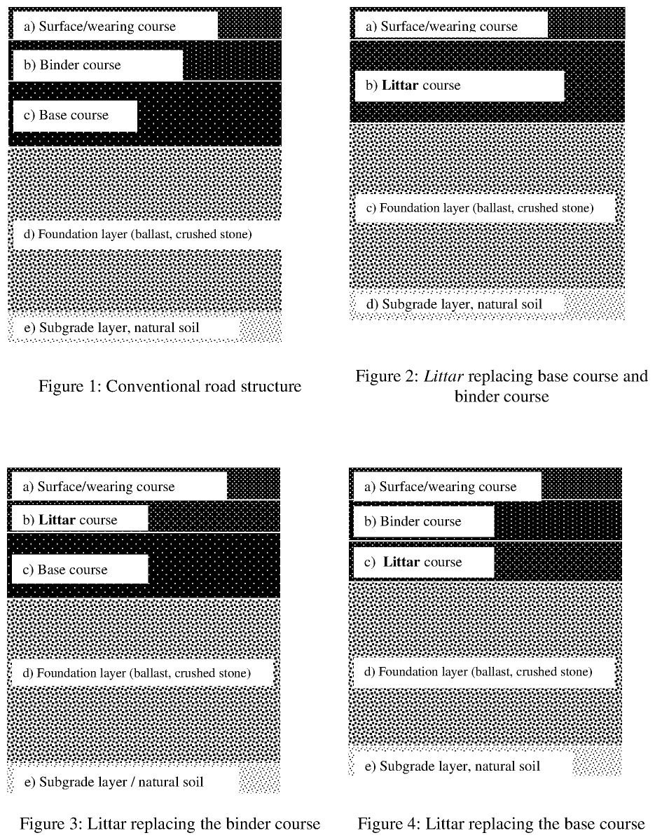

### 7. DETAILED PRESENTATION OF AT LEAST ONE EMBODIMENT OF THE INVENTION

In order to use any Littar composition commercially, it should be technically tested and approved by an authorized entity. Therefore, a scientific study was conducted to determine the performance of a composition using only recycled glass and plastic aggregates, while complying with the criteria specific to an asphalt mixture. This resulted in a composition called Littar Base, which can be used as a substitute for conventional base and binder courses of light-traffic roads, such as technical class 5 roads (EU), sidewalks, parking lots, driveways, platforms or other similar applications.

The optimal composition and technical specifications of Littar Base material using exclusively glass and plastic aggregates are summarized in Table 1.

The use of less glass and more plastic creates problems in the mixing process carried out in conventional asphalt mixing plant. In addition, the use of a smaller amount of glass results in insufficient heat capacity of the material which in turn causes rapid cooling during transport and subsequent problems during application.

The use of more glass and less plastic would improve the mixing characteristics and heat transfer but would decrease the strength of the material, as measured by the Marshall Stability and Creep Index and the modulus of rigidity. Finally, the use of too little bitumen would lead to a complete non-coating of the particles after mixing. The use of more bitumen would lead to lower strength of the material.

Further laboratory tests were carried out to obtain a material composition, for base and binder courses, that meets all design criteria and test standards for bituminous road mixtures of a higher technical class: 3, 4 and 5 (according to AND IND 605-2018). The study led to the design of a new Littar mixture composition made of recycled waste glass, plastics and conventional aggregates such as quarry rock, sand and filler, hereinafter referred to as Littar—final composition.

TABLE 1
Constituents and technical characteristics of Littar Base material
Littar Base (only with glass and plastic aggregates)

| | | | | | | | | Minimum |
|---|---|---|---|---|---|---|---|---|
| | | | | | | | | Thickness |
| | | | | Marshall | Modulus | Apparent | Maximum | of Base |
| | | | Content | Stability | of Rigidity | Density | Density | Course |
| Constituents | Particle Size | | by Weight | [kN] | [MPa] | [Kg/m³] | [Kg/m³] | [cm] |
| Plastic | 0-10 | mm | 31.5% | 4.8 | 1,571 | 1,258 | 1,402 | 8 |
| Glass | 0-4 | mm | 61% | | | | | |

| | | |
|---|---|---|
| Bitumen | N/A | 7.5% |
| 50/70 | | |

TABLE 2
Constituents and technical characteristics of Littar material (final composition)
Littar (final composition)

| | | | | | | | | Minimum |
|---|---|---|---|---|---|---|---|---|
| | | | | | | | | Thickness |
| | | | | Marshall | Modulus | Apparent | Maximum | of Base |
| | Particle Size | | Content | Stability | of Rigidity | Density | Density | Course |
| Constituents | (grade) | | by Weight | [kN] | [MPa] | [Kg/m³] | [Kg/m³] | [cm] |
| Plastic | 0/10 | mm | 10.0% | 12.8 | 5,709 | 1,976 | 2,141 | 8 |
| Glass | 0/4 | mm | 17.0% | | | | | |
| | 4/8 | mm | 8.0% | | | | | |
| Sand | 0/4 | mm | 15.0% | | | | | |
| Mineral | 8/16 | mm | 23.0% | | | | | |
| aggregate | 16/22.4 | mm | 23.0% | | | | | |

| | | |
|---|---|---|
| Filler | N/A | 4.0% |
| Bitumen | N/A | 4.6% |
| 50/70 | | |

This final composition resulted in an optimum glass and plastic content for use in technical class 3, 4 and 5 road applications. The use of a larger amount of plastic and glass results in a lower modulus of rigidity than the requirements set by AND ind 605-2018, for base and binder courses of class 3 and 4 roads.

The compositions shown in Table 1 and Table 2 have resulted in scientifically verified asphalt mixtures through laboratory tests, that can be used for a wide range of applications. Based on laboratory research, the mass percentage of Littar constituents should comply with the values established and included in Table 3.

TABLE 3
Littar components and mass percentages of constituents

| | | | Littar final |
|---|---|---|---|
| | | Littar Base | composition |
| | Constituents | Mass Percentages | |
| 100% | Glass aggregates | 55-70% | 15-40% |
| | Plastic | 25-40% | 5-20% |
| | Mineral | 0 | 40-75% |
| | aggregates | | |
| | Filler | 0-5% | 3-5% |
| Percentages added | Bitumen | 5-10% | 4-6% |
| over total mass of other | | | |
| constituents | | | |

The preparation of glass aggregates starts by crushing bulk mixtures of waste products from recovered glass (all types and colors) into granules the sizes of which are included in two grades: 0/4 mm and 4/8 mm. Glass crushing is done with conventional machines such as imploder glass crushers, etc. Ideally, crushed glass is washed and dried before being used as an aggregate.

The preparation of plastic aggregates starts with the selection of bulk mixtures of recovered plastic waste with resin identification code (RIC) 1 to 7 and ABS, depending on the local availability, the bulk mixture of plastic materials may exist in different combinations and quantities. The requirement is that most of the material in the bulk mixture contains at least one type of plastic with RIC code 2, 4, 5, 6 or ABS as shown in Table 4.

TABLE 4
Types of plastic and quantities required to become Littar constituent

| | | Bulk | |
|---|---|---|---|
| | | Mixture | |
| | | Content | |
| | | by | |
| RIC | Plastic Type | Weight | Remarks |
| 2 | High Density | ≥60% | The bulk mixture must |
| | Polyethylene (HDPE) | | contain at least one |
| 4 | Low Density | | type or a combination |
| | Polyethylene (LDPE) | | of the 5 types |
| 5 | Polypropylene (PP) | | |
| 6 | Polystyrene (PS) | | |
| ABS | Acrylonitrile butadiene | | |
| | styrene | | |
| 1 | Polyethylene | ≤40% | The quantity of type 1 and/or |
| | terephthalate (PET) | | type 7 plastic shall be limited to |
| 7 | Other (Nylon, | | a maximum of 40% of the total |
| | Polycarbonate, etc.) | | weight of the bulk mixture. |
| 3 | Polyvinyl chloride | ≤2% | The use of PVC shall be limited |
| | (PVC) | | to a maximum of 2% to prevent |
| | | | a toxicity level, caused by |
| | | | gaseous hydrochloric acid |
| | | | during production or application |

After selecting the bulk mixture of plastic waste, it is shredded into granules with a maximum size of about 10 mm. For ideal performance, the shredded plastic is washed and dried before being used in mixtures.

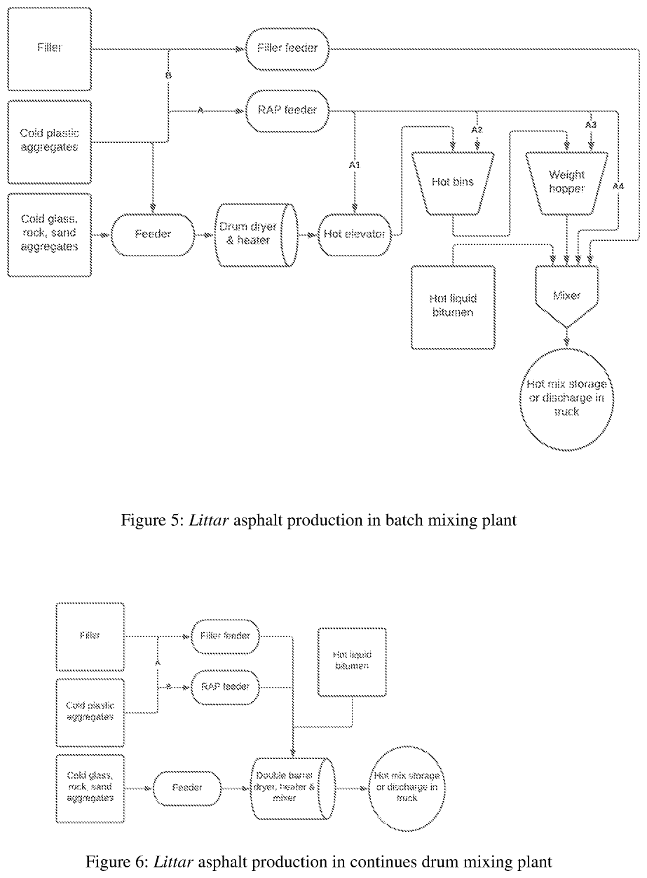

The method of producing the Littar mixture in asphalt mixing plants (FIG. 5) starts by heating the glass, mineral aggregates (in the dryer and heating drum of the plant) to 160-180° C. Liquid bitumen is introduced into the mixer at a temperature of 180° C. over the aggregates. Mix in the mixer for 30-35 sec., at 180° C., and then add the shredded plastic constituent and mix for a further 10-15 sec., resulting in a polymerized asphalt mixture.

The shredded plastic is preferably fed into the mixture through the RAP feed system (A). The use of the Recycled Asphalt Pavement (RAP) feed system allows several options for feeding plastic aggregate (A1, A2, A3 or A4) into the mixture.

The final hot mixture is discharged into trucks which are covered to avoid cooling. The transport and application/placing of the Littar mixture is carried out with conventional road construction machinery.

The method of producing Littar material using drum stations (with 1 or 2 drums/tanks) by continuous mixing is shown in FIG. 6. The process starts with heating the glass and mineral aggregates to 160-180° C. in the dryer and drum heater. The plastic aggregates are fed into the mixture through the feed system (A) or the RAP feed system (B).

An important condition to be observed in both methods of obtaining the material is that the plastic is dry and never in direct contact with the flame of the burner. Plastics must not enter the full melt and flow phase, they must remain soft and flexible for correct application of the Littar mixture when using conventional road paving machinery. In addition to the methods described above, other means of adding plastic to the mixture are possible, but these require modifications to conventional equipment in asphalt plants.

The Littar mixture is placed and compacted with the same machines and under the same conditions used for conventional asphalt mixtures. The minimum temperature for placing and compacting Littar mixture is 80° C. Depending on the plastic content of the mixture, additional passes of the roller may be required to achieve the required compaction density. In addition, the plastic content of Littar requires the initial thickness of the road layer to be greater than the final compacted thickness required. It is recommended to use a “screed heating” system for the mixing layer to ensure the ideal placing and compaction temperature and that the flame of the heating system has no direct contact with the material.

1. Asphalt concrete for base and binder layers of roads characterized in that it comprises waste glass aggregates form 15 gr % to 70 gr %, waste plastic material from 5 gr % to 40 gr %, mineral aggregates form 0 gr % to 75 gr %, filler from 0 gr % to 5 gr % and bitumen from 4 gr % to 10 gr % of the total weight of the asphalt concrete.

2. Asphalt concrete according to claim 1 characterized in that it comprises waste glass aggregates from 55 to 70 gr %, waste plastic material from 25 to 40 gr %, filler from 0 to 5 gr % and bitumen from 5 to 10 gr %.

3. Asphalt concrete according to claim 1 characterized in that it comprises waste glass aggregates from 15 to 40 gr %, waste plastic material from 5 to 20 gr %, mineral aggregates form 40 gr % to 75 gr %, filler from 3 to 5 gr % and bitumen from 4 to 6 gr %.

4. Asphalt concrete according to claim 1 characterized in that it comprise waste glass aggregates with a granularity of 0/4 mm and waste plastic material with a granularity of 0/10 mm.

5. Asphalt concrete according to claim 1, characterized in that it comprises waste glass aggregates of the 0/4 and 4/8 mm granularity in an amount of 15 gr % to 40 gr % of the total weight of asphalt concrete, and waste plastic materials of 0/10 mm granularity, in an amount of 5 gr % to 20 gr % of the total mass of asphaltic concrete, mineral aggregates in an amount 40 gr % to 70 gr %, filler in an amount of 3 gr % to 5 gr %, percentages related to the total mass of asphalt concrete.

6. Asphalt concrete according to claim 1, characterized in that the waste plastic materials are selected from
polyethylene (HDPE and LDPE), polypropylene, polystyrene or ABS, together represent a percentage of at least 60% of the total mass of waste plastic material;
polyethylene terephthalate—PET, or other plastic materials, to represent a percentage of no more than 40% of the total mass of waste plastic material;
polyvinyl chloride-PVC limited to no more than 2% of the total mass of waste plastic material.

7. Asphalt concrete according to claim 1, characterized in that the waste plastic materials are comprised of recycled waste plastics and waste glass aggregates are comprised of recycled waste glass.

8. Method for obtaining an asphalt concrete defined in claim 1, characterized in that it comprise the following steps:
mixing of waste glass aggregates together with the filler at 160-180° C.,
adding the road bitumen heated to 180° C., and mixing for 30-35 sec.
adding the waste plastic material and mixing for another 10-15 sec.

9. Use of asphalt concrete defined in claim 1 for base layer and/or binder layer of roads.

10. Use of the asphalt concrete defined in claim 3 for the binder layer of roads.
